(19) United States
(12) Patent Application Publication
(10) Pub. No.: US 2003/0201570 A1
(43) Pub. Date: Oct. 30, 2003

(54) Injection molding method, injection mold, resin-molded article, and insert resin component

(75) Inventors: Yoshiaki Sasatani, Ibaraki (JP); Kenshirou Abe, Ibaraki (JP); Masatoshi Watanabe, Ibaraki (JP); Tetsuya Sonobe, Ibaraki (JP)

Correspondence Address: FITZPATRICK CELLA HARPER & SCINTO, 30 ROCKEFELLER PLAZA, NEW YORK, NY, 10112, US

(73) Assignees: CANON KABUSHIKI KAISHA, TOKYO (JP); CANON KASEI KABUSHIKI KAISHA, IBARAKI (JP)

(21) Appl. No.: 10/406,195

(22) Filed: Apr. 4, 2003

(30) Foreign Application Priority Data
Apr. 4, 2002 (JP) 102588/2002(PAT.)
Mar. 19, 2003 (JP) 075806/2003(PAT.)

(51) Int. Cl. B29C 45/16

(52) U.S. Cl. 264/250; 425/130

(57) ABSTRACT

The object of the invention is, in integrating two or more types of resin materials having different compositions or tones in a mold, thus molding a multi-color, multi-material molded article, to increase the strength of the bonding surfaces of the resins. To achieve this object, this invention provides an injection molding method of injecting two or more types of resin materials having different compositions or tones into a mold, thus producing a molded article in which the two or more types of resin materials are bonded. Convexo-concave shapes are formed on the bonding portions of the two or more types of resin materials.

### FIELD OF THE INVENTION

The present invention relates to a technique for producing a molded article in which two or more types of resin materials having different compositions or tones are bonded to each other.

### BACKGROUND OF THE INVENTION

When two or more types of resin materials having different compositions or tones must be injected into a mold because of physical demands or design demands so that a molded article which is bonded in the mold can be obtained, a two-color molding method is conventionally used.

According to the two-color molding method, first, the first molten resin is injected into the first cavity to mold the first resin portion. Subsequently, the second molten resin is injected into the second cavity adjacent to the first cavity, thus molding the second resin portion. Hence, the first and second resin portions are welded to each other, and an integral two-color molded article is formed.

With the two-color molding method, the first and second cavities are sometimes partitioned from each other in order to regulate the first molten resin from flowing into the second cavity, so that the bonding portion of the first and second molten resins becomes clear. As a method for this purpose, when a plurality of different molds are used, the first and second cavities are partitioned by the molds themselves. When a single type of mold is used, the first and second cavities are partitioned by a movable core. Alternatively, a molded article is fabricated by one mold using one resin, and is insert-molded in a different mold having the shape of the final product.

FIG. 11A is a view showing an example of a conventional injection molded article, and FIGS. 11B, 11C, 11D, and 11E are views showing molds that produce the conventional injection molded article shown in FIG. 11A, and their molding processes.

Referring to FIG. 11A, reference numeral 39 denotes a product portion formed of the first resin; 40, a product portion formed of the second resin; and 41, a merging portion of the first and second resins. Referring to FIG. 11B, reference numeral 64 denotes a stationary nesting piece; 65, a movable nesting piece; 66, a sprue gate for injecting the first resin; 67, a sprue gate for injecting the second resin; 68, the first resin which is being filled; and 69, the second resin which is being filled.

Referring to FIG. 11C, reference numeral 70 denotes a first stationary nesting piece; 71, a movable nesting piece; 72, a sprue gate for injecting the first resin; 73, the first resin which is being filled; 74, a second stationary nesting piece to be filled with the second resin; 75, a first product portion formed of the first resin; 76, a sprue gate for injecting the second resin; 77, the second resin which is being filled; and 78, a second product portion formed of the second resin.

Referring to FIG. 11D, reference numeral 79 denotes a stationary nesting piece; 80, a movable nesting piece; 81, a movable core; 82, a first sprue gate for injecting the first resin; 83, a second sprue gate for injecting the second resin; 84, the first resin which is being filled; 85, a first product portion formed of the first resin; 86, a sprue gate for injecting the second resin; 87, the second resin which is being filled; and 88, a second product portion formed of the second resin.

Referring to FIG. 11E, reference numeral 89 denotes a stationary nesting piece; 90, a movable nesting piece; 91, an insert component formed of the first resin; 92, a sprue gate for injecting the second resin; 93, the second resin which is being filled; and 94, a product portion formed of the second resin.

When the two-color molded article as shown in FIG. 11A is to be obtained, according to one method, the mold as shown in FIG. 11B is used, and the first and second resins 68 and 69 are respectively injected from the sprue gates 66 and 67 simultaneously, so that the merging portion 41 of the first and second resins is formed by the behavior of the resin flow.

Alternatively, as shown in FIG. 11C, the first resin 73 is filled from the sprue gate 72 into the cavity defined by the first stationary nesting piece 70 and movable nesting piece 71, to mold the first product portion 75. Then, the mold is opened temporarily. At this time, the first product portion 75 is left on the movable nesting piece 71 side, and moves together with the movable nesting piece 71 to the position for the second stationary nesting piece 74. The second stationary nesting piece 74 has a cavity for accommodating the first product portion 75 and forming the second product portion 78. When the second resin 77 is injected from the sprue gate 76 through which it is to be injected, the second product portion 78 is formed, and the product as shown in FIG. 11A can be obtained.

FIG. 11D shows a method of partitioning the cavity by using a movable core. The movable core 81 is entered in a cavity defined by the stationary nesting piece 79 and movable nesting piece 80, so as to halve the cavity. The first resin 84 is filled into one half of the halved cavities from the first sprue gate 82 through which it is to be filled. Upon a lapse of a predetermined cooling time, the product portion 85 is formed of the first resin 84. Then, the movable core 81 is removed from the cavity by using a driving means such as an air cylinder, so that the cavities for respectively forming the first and second product portions 85 and 88 communicate with each other. The second resin 87 is injected from the sprue gate 86 through which it is to be injected. The second product portion 88 is thus formed, and is integrated with the first product portion 85.

FIG. 11E shows a method of integrating, by insert molding, the product portion formed of the first resin and the product portion formed of the second resin. The insert component 91 molded by a separated molded in advance and formed of the first resin is inserted in the cavity defined by the stationary nesting piece 89 and movable nesting piece 90. The second resin 93 is injected from the sprue gate 92 through which it is to be injected, so that the insert component 91 is integrated with the second product portion 94.

Conventionally, in multi-color, multi-material molding of injecting two or more types of resin materials having different compositions or tones into a mold, thus obtaining a molded article which is bonded in the mold, when the bonding surfaces of the two or more types of resins are bonded to have a shape formed of a single straight line or cured line, as the areas of the bonding surfaces are limited, problems may occur in the function, e.g., in the strength of the bonding surfaces.

When multi-color, multi-material molding is performed without using any movable core, the bonding surfaces cannot have special forms, and accordingly problems may occur in the function, e.g., in the strength of the bonding surfaces.

Furthermore, the boundary surface may become very unclear, which is undesirable in terms of design.

When multi-color, multi-material molding is to be performed by using a movable core, according to one method, molding is performed after by the first and second resin molding temperatures are set equal to each other. When the first resin reaches the movable core, its skin is cooled to form a skin layer, and after that, the second resin is bonded. According to this method, as the first and second resins are fused after cooling has advanced, the first and second resins are not bonded to each other sufficiently. Then, sometimes problems occur in the function, e.g., in the strength of the bonding surfaces.

The same problem sometimes occurs in insert molding.

### SUMMARY OF THE INVENTION

The present invention has been made in view of the problems described above, and has as its object to improve the strength of the bonding surfaces of resins when a multi-color, multi-material molded article is to be molded by integrating two or more types of resin materials having different compositions or tones in a mold.

In order to solve the above problems and to achieve the above object, according to the first aspect of the present invention, there is provided an injection molding method of injecting not less than two types of resin materials having different compositions or tones into a mold, thus producing a molded article in which at least two types of resin materials are bonded, characterized in that bonding portions of the not less than two types of resin materials are shaped in convexo-concave.

According to the second aspect of the present invention, there is provided an injection molding method of injecting not less than two types of resin materials having different compositions or tones into a mold, thus producing a molded article in which at least two types of resin materials are bonded, characterized in that bonding portions of the at least two types of resin materials are shaped overlappingly in a direction of thickness thereof.

According to the third aspect of the present invention, there is provided an injection molding method of producing a molded article in which not less than two types of resin materials having different compositions or tones are bonded, characterized by comprising an arrangement step of arranging at least one resin-molded component in a cavity of a mold in advance, and an injection step of injecting into the cavity a resin material having a composition or tone different from that of at least one resin-molded component, wherein a convexo-concave shape is formed in a bonding portion of at least one resin-molded component with respect to the resin material which is to be injected into the cavity.

According to the fourth aspect of the present invention, there is provided an injection molding method of producing a molded article in which not less than two types of resin materials having different compositions or tones are bonded, characterized by comprising an arrangement step of arranging at least one resin-molded component in a cavity of a mold in advance, and an injection step of injecting into the cavity a resin material having a composition or tone different from that of at least one resin-molded component, wherein a bonding portion of at least one resin-molded product is shaped overlappingly in a direction of thickness thereof with respect to the resin material which is to be injected into the cavity.

According to the fifth aspect of the present invention, there is provided an injection molding method of injecting first and second resin materials having different compositions or tones into a mold, thus producing a molded article in which the first and second resin materials are bonded, characterized by comprising an entering step of entering, in a second portion of a cavity of the mold which is to be filled with the second resin material, a movable piece for forming a convexo-concave shape in a bonding portion of the first resin material which is to be bonded to the second resin material, a first injection step of injecting the first resin material into a first portion of the cavity which is to be filled with the first resin material, a removal step of removing the movable piece from the second portion of the cavity, and a second injection step of injecting the second resin material into the second portion of the cavity.

According to the sixth aspect of the present invention, there is provided an injection molding method of injecting first and second resin materials having different compositions or tones into a mold, thus producing a molded article in which the first and second resin materials are bonded, characterized by comprising an entering step of entering, in a second portion of a cavity of the mold which is to be filled with the second resin material, a movable piece for forming a bonding portion of the first resin material which is to be bonded to the second resin material, such that the bonding portion is shaped overlappingly in a direction of thickness thereof with respect to the second resin material, a first injection step of injecting the first resin material into a first portion of the cavity which is to be filled with the first resin material, a removal step of removing the movable piece from the second portion of the cavity, and a second injection step of injecting the second resin material into the second portion of the cavity.

According to the seventh aspect of the present invention, there is provided an injection mold for producing a molded article in which first and second resin materials having different compositions or tones are bonded, characterized by comprising a mold member for defining a cavity having a first portion to be filled with the first resin material and a second portion to be filled with the second resin material, and a movable piece arranged to be able to enter and removable from the second portion, to form a convexo-concave shape in a bonding portion of the first resin material which is to be bonded to the second resin material.

According to the eighth aspect of the present invention, there is provided an injection mold for producing a molded article in which first and second resin materials having different compositions or tones are bonded, characterized by comprising a mold member for defining a cavity having a first portion to be filled with the first resin material and a second portion to be filled with the second resin material, and a movable piece arranged to be able to enter and removable from the second portion, to form a bonding portion of the first resin material which is to be bonded to the second resin material, such that the bonding portion is shaped overlappingly in a direction of thickness thereof with respect to the second resin material.

According to the ninth aspect of the present invention, there is provided a resin-molded article in which not less than two types of resin materials having different compositions or tones are bonded, characterized in that bonding portions of the not less than two types of resin materials are shaped in convexo-concave.

According to the 10th aspect of the present invention, there is provided a resin-molded article in which not less than two types of resin materials having different compositions or tones are bonded, characterized in that bonding portions of the not less than two types of resin materials are shaped overlappingly in a direction of thickness thereof.

According to the 11th aspect of the present invention, there is provided an insert resin product which is to be integrated in a cavity of a mold with another resin material having a different composition or tone, characterized in that a bonding portion with another resin material is shaped in convexo-concave.

According to the 12th aspect of the present invention, there is provided an insert resin product which is to be integrated with another resin material having a different composition or tone in a cavity of a mold, characterized in that a bonding portion of the insert resin product is shaped overlappingly in a direction of thickness thereof with respect to another resin material.

According to the 13th aspect of the present invention, there is provided a method of performing injection molding to produce a molded article by using a plurality of resin materials, characterized in that a movable core is formed in a cavity of a mold for molding the molded article, to have a convexo-concave shape which is to come into contact with a resin, the movable core is positioned in the cavity and a first resin material is injected to form a convexo-concave shape in part of the molded article, then the movable core is removed and a second resin material is injected to a portion from which the movable core has been removed, and a portion of the first resin material which has the convexo-concave shape is fused again at an injection temperature of the second resin material, thereby bonding the first and second resin materials.

According to the 14th aspect of the present invention, there is provided a toner container having a tab which is molded from a plurality of resin materials having different injection temperatures, characterized in that injection for molding a main body portion of the toner container is performed by injecting a first resin material into a cavity of a mold which molds the toner container, then a second injection material having an injection temperature higher than that of the first resin material is injected, and a portion of the second resin material which is in contact with the first resin material is fused again, thereby forming the tab.

Other features and advantages of the present invention will be apparent from the following description taken in conjunction with the accompanying drawings, in which like reference characters designate the same or similar parts throughout the figures there.

### BRIEF DESCRIPTION OF THE DRAWINGS

FIG. 1 is a view showing the first example of a molded article as one embodiment of the present invention;

FIG. 2 is a view showing the second example of a molded article as one embodiment of the present invention;

FIG. 3 is a view showing the third example of a molded article as one embodiment of the present invention;

FIG. 4 is a view showing the fourth example of a molded article as one embodiment of the present invention;

FIG. 5 is a view showing the fifth example of a molded article as one embodiment of the present invention;

FIG. 6 is a view showing an example of an injection mold according to one embodiment of the present invention;

FIG. 7 is a view showing an example of an injection mold according to one embodiment of the present invention;

FIG. 8A is a view showing an example of a molded article molded by a molding method according to one embodiment of the present invention;

FIG. 8B is an enlarged view of a portion to which the present invention is applied;

FIG. 9A is a view showing an assembly section of an injection mold used in one embodiment of the present invention;

FIG. 9B is an enlarged view of that portion of the injection mold used in one embodiment of the present invention, which is around a product portion;

FIG. 9C is a view showing the operation of the movable core of the injection mold used in one embodiment of the present invention;

FIG. 9D is a view showing the operation of the movable core of the injection mold used in one embodiment of the present invention;

FIG. 10 is a view showing an example of a general two-color molding machine used in one embodiment of the present invention;

FIG. 11A is a view for explaining a conventional injection-molded article;

FIG. 11B is a view for explaining an injection mold and molding process for producing a conventional injection-molded article;

FIG. 11C includes views for explaining an injection mold and molding process for producing a conventional injection-molded article;

FIG. 11D includes views for explaining an injection mold and molding process for producing a conventional injection-molded article;

FIG. 11E includes views for explaining an injection mold and molding process for producing a conventional injection-molded article;

FIG. 12 includes views for comparing the bonding strengths of the injection-molded articles as the embodiments shown in FIGS. 1, 3, and 4 with that of the conventional injection-molded article shown in FIG. 11A; and

FIG. 13 includes views and a table for comparing the bonding strength of an injection molded article obtained when the temperature of the second resin is higher than that of the first resin with that of an injection molded article obtained when the temperature of the second resin is not higher than that of the first resin.

### DETAILED DESCRIPTION OF THE PREFERRED EMBODIMENTS

The preferred embodiments of the present invention will be described.

The outline of one embodiment will be described first.

According to this embodiment, regarding the shape of a molded article obtained in accordance with multi-color, multi-material molding of injecting two or more types of resin materials having different compositions or tones into a mold, thus obtaining a molded article which is bonded in the mold, the bonding surfaces of the two types of resins have undulating shapes formed of a plurality of straight lines or curved lines. Hence, the areas of the bonding surfaces are larger than in a case wherein the bonding surfaces are formed of a single straight line or curved line.

More specifically, to increase the areas of the bonding surfaces of the respective resins increases the strength of the bonding surfaces of the resins.

Regarding the shape of a molded article obtained in accordance with multi-color, multi-material molding of injecting two or more types of resin materials having different compositions or tones into a mold, thus obtaining a molded article which is bonded in the mold, the undulating shapes formed on the bonding surfaces of the two types of resins enlarge more as they enter the opposite members more. Hence, the areas of the bonding surfaces are larger than in a case wherein the bonding surfaces are formed of a single straight line or curved line.

More specifically, to increase the areas of the bonding surfaces of the respective resins and furthermore to form the undulating shapes on the bonding surfaces such that they enlarge more as they enter the opposite members more increase the strength of the bonding surfaces of the resins.

Regarding the shape of a molded article obtained in accordance with multi-color, multi-material molding of injecting two or more types of resin materials having different compositions or tones into a mold, thus obtaining a molded article which is bonded in the mold, the bonding surfaces of the resins are shaped overlappingly in the direction of the thickness. Hence, the areas of the bonding surfaces are larger than in a case wherein the bonding surfaces are formed of a single straight line or curved line.

More specifically, to increase the areas of the bonding surfaces of the respective resins increases the strength of the bonding surfaces of the resins.

In insert molding of inserting a member formed of a resin material having a composition or tone different from that of a molten resin into a mold in advance and injecting the molten resin into the mold, thus integrating the resin member with the molten resin, the bonding surfaces of the resins are shaped as described above.

More specifically, to increase the areas of the bonding surfaces of the respective resins increases the strength of the bonding surfaces of the resins.

Regarding a mold for multi-color, multi-material molding of injecting two or more types of resin materials having different compositions or tones into a mold, thus obtaining a molded article which is bonded in the mold, a movable core with the shape described above is entered in a cavity where the respective resins are to be bonded, thus forming the shape described above. The first resin is filled in the cavity, and after that the movable core is removed from the cavity, thus forming a new cavity. The second resin is injected into the new cavity, and is allowed to flow to the bonding surface, so that it is bonded to the first resin.

More specifically, a mold having a movable core with the shape described above is used for forming the bonding surfaces of the respective resin portions. Hence, in the bonding portion, the first resin is already in the cooling step, thus forming a skin layer. As a result, an integral molded article in which the bonding interface from the second resin is defined well can be manufactured, and an integral molded article in which the strength of the bonding surfaces of the resins is increased can be manufactured.

Regarding a molding method for multi-color, multi-material molding of injecting two or more types of resin materials having different compositions or tones into a mold, thus obtaining a molded article which is bonded in the mold, a movable core is entered in a cavity to a portion where the respective resins are to be bonded, so that the flow of the first resin is regulated for a predetermined period of time. After that, the movable core is removed from the cavity, and the second resin is caused to flow to the bonding portion at a molding temperature higher than the molding temperature of the first resin.

More specifically, the second resin is caused to flow to the bonding portion at a molding temperature higher than the molding temperature of the first resin. Hence, the skin layer which is formed as the skin of the first resin cools can be fused again by the temperature of the second resin. This can increase the adhesion properties of the resins and the strength of the bonding surfaces.

One embodiment of the present invention will be described in detail with reference to the accompanying drawings.

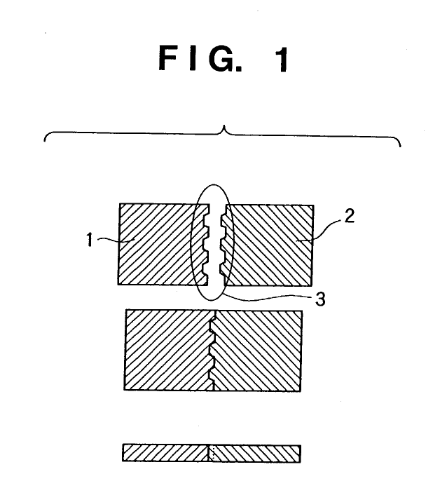

FIG. 1 is a view showing the first example of a molded article as one embodiment of the present invention.

As shown in FIG. 1, in multi-color, multi-material molding of injecting two or more types of resin materials having different compositions or tones into a mold, thus obtaining a molded article which is bonded in the mold, a product portion 1 formed of the first resin, e.g., black HIPS, and a product portion 2 formed of the second resin, e.g., orange GPPS, have undulated (convexo-concave) shapes formed of a plurality of straight lines or curved lines on the bonding surfaces of the two types of resins. The first and second product portions 1 and 2 are bonded to each other at a merging portion 3 for the first and second resins, thus forming an integral molded article.

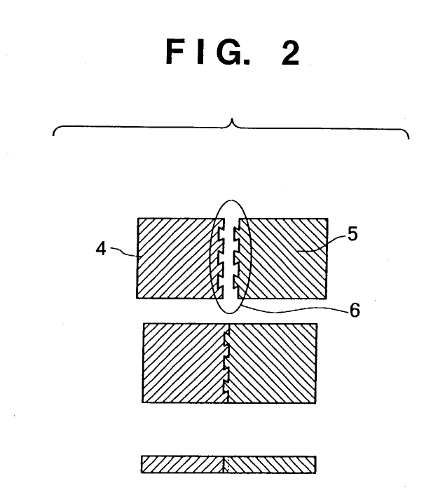

FIG. 2 is a view showing the second example of the molded article as one embodiment of the present invention.

As shown in FIG. 2, in multi-color, multi-material molding of injecting two or more types of resin materials having different compositions or tones into a mold, thus obtaining a molded article which is bonded in the mold, a product portion 4 formed of the first resin and a product portion 5 formed of the second resin have undulated (convexo-concave) shapes formed of a plurality of straight lines or curved lines on the bonding surfaces (merging portion 6) of the two types of resins. The undulated (convexo-concave) shapes enlarge more as they enter the opposite members more. The first and second resins are bonded to each other at the merging portion 6, thus forming an integral molded article.

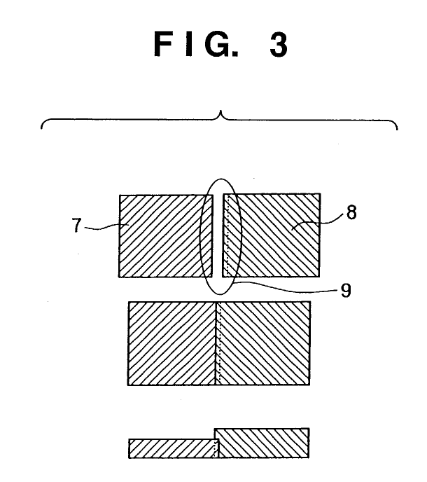

FIG. 3 is a view showing the third example of the molded article as one embodiment of the present invention.

As shown in FIG. 3, in multi-color, multi-material molding of injecting two or more types of resin materials having different compositions or tones into a mold, thus obtaining a molded article which is bonded in the mold, a product portion 7 formed of the first resin and a product portion 8 formed of the second resin are shaped overlappingly in the direction of thickness on the bonding surfaces (merging portion 9) of the two types of resins. The first and second resins are bonded to each other at the merging portion 9, thus forming an integral molded article.

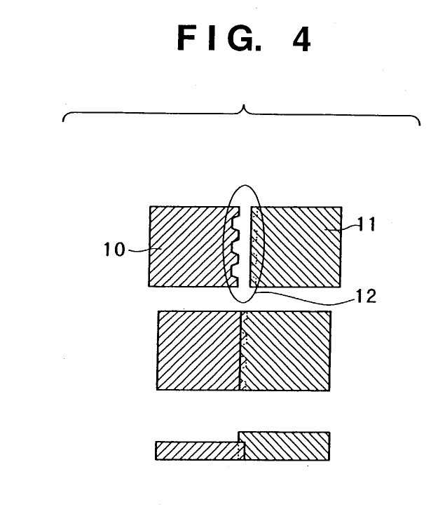

FIG. 4 is a view showing the fourth example of the molded article as one embodiment of the present invention.

As shown in FIG. 4, in multi-color, multi-material molding of injecting two or more types of resin materials having different compositions or tones into a mold, thus obtaining a molded article which is bonded in the mold, a product portion 10 formed of the first resin and a product portion 11 formed of the second resin have undulated (convexo-concave) shapes formed of a plurality of straight lines or curved lines on the bonding surfaces (merging portion 12) of the two types of resins. Also, the product portions 10 and 11 are shaped overlappingly in the direction of thickness, on the bonding surfaces of the two types of resins. The first and second resins are bonded to each other at the merging portion 12, thus forming an integral molded article.

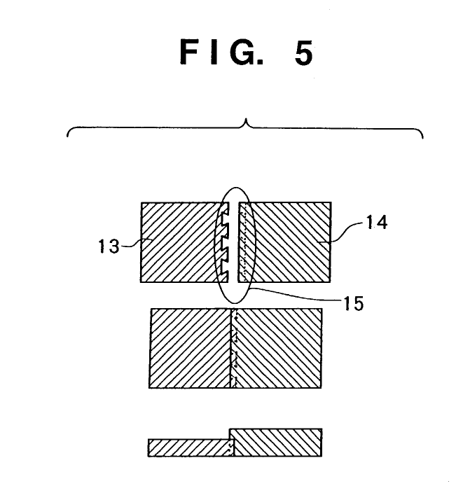

FIG. 5 is a view showing the fifth example of the molded article as one embodiment of the present invention.

As shown in FIG. 5, in multi-color, multi-material molding of injecting two or more types of resin materials having different compositions or tones into a mold, thus obtaining a molded article which is bonded in the mold, a product portion 13 formed of the first resin and a product portion 14 formed of the second resin have undulated (convexo-concave) shapes formed of a plurality of straight lines or curved lines on the bonding surfaces (merging portion 15) of the two types of resins. The undulated (convexo-concave) shapes enlarge more as they enter the opposite members more, and overlap on each other in the direction of thickness on the bonding surfaces of the two types of resins. The first and second resins are bonded to each other at the merging portion 15, thus forming an integral molded article.

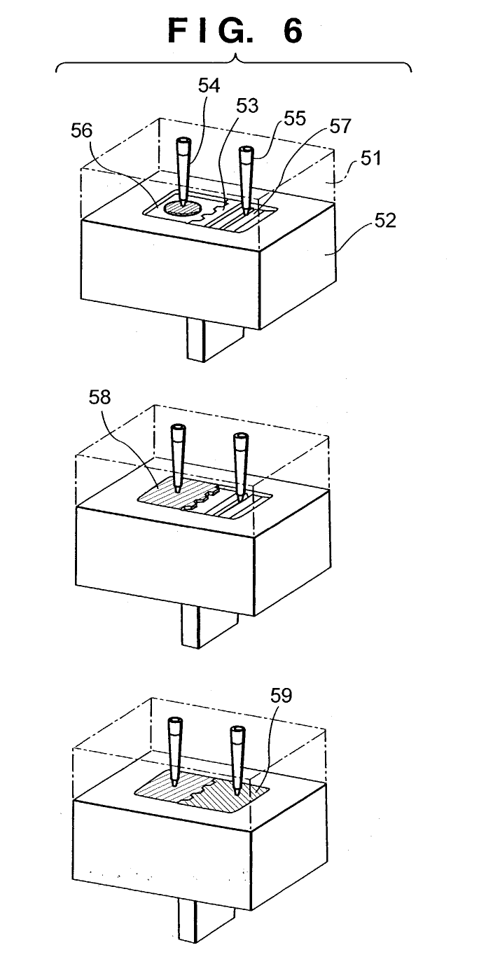

FIG. 6 includes views showing an example of an injection mold according to one embodiment of the present invention. Referring to FIG. 6, reference numeral 51 denotes a stationary nesting piece; 52, a movable nesting piece; 53, a movable core; 54, a sprue gate for injecting the first resin; 55, a sprue gate for injecting the second resin; 56, a first cavity to be filled with the first resin; 57, a second cavity to be filled with the second resin; 58, a first product portion formed of the first resin; and 59, a second product portion formed of the second resin.

With the above arrangement, in two-color, two-material molding of injecting two types of resin materials having different compositions or tones into a mold, thus obtaining a molded article which is bonded in the mold, the movable core 53 having a bonding surface with the shape shown in either one of FIGS. 1 to 5 is entered into the cavity of the movable nesting piece 52, so that the first cavity 56 to be filled with the first resin and the second cavity 57 to be filled with the second resin are formed. That side surface of the movable core 53 which is on the first cavity 56 side has a bonding surface with the shape shown in either one of FIGS. 1 to 5. The first resin injected through the sprue gate 54, through which it is to be injected, comes into contact with that side surface of the movable core 53 which is on the first cavity 56 side, while filling the first cavity 56, so as to form a bonding surface with the shape shown in either one of FIGS. 1 to 5. After that, the movable core 53 is removed from the cavity of the movable nesting piece 52 by using a driving means such as an air cylinder, so that the first product portion 58 formed of the first resin and the second cavity 57 to be filled with the second resin communicate with each other. The second resin that has passed through the sprue gate 55, through which it is to be injected, flows to the bonding surface with respect to the first product portion 58 formed of the first resin, while filling the second cavity 57, so as to form the second product portion 59. The first and second product portions 58 and 59 form a molded article which is bonded through bonding surfaces with the shapes shown in either one of FIGS. 1 to 5.

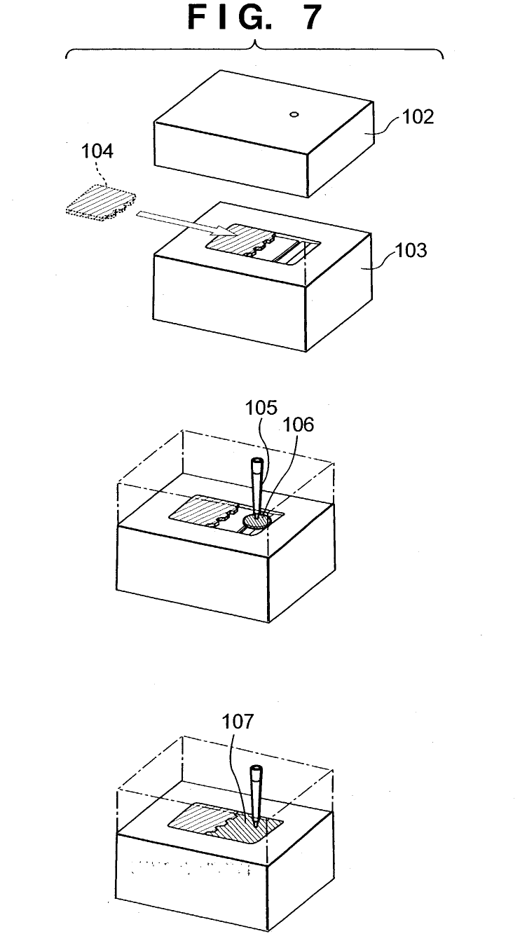

FIG. 7 includes views showing an example of a method of integrating a product portion formed of the first resin and a product portion formed of the second resin by means of insert molding using an injection mold according to one embodiment of the present invention.

Referring to FIG. 7, reference numeral 102 denotes a stationary nesting piece; 103, a movable nesting piece; 104, an insert component formed of the first resin; 105, a sprue gate for injecting the second resin; 106, the second resin which is being filled; and 107, a product portion formed of the second resin.

In the above arrangement, the insert component 104 molded by another mold in advance and formed of the first resin is inserted in the cavity defined by the stationary nesting piece 102 and movable nesting piece 103, and the second resin 106 is injected from the sprue gate 105 through which it is to be injected. Thus, the insert component 104 is integrated with the product portion 107 formed of the second resin.

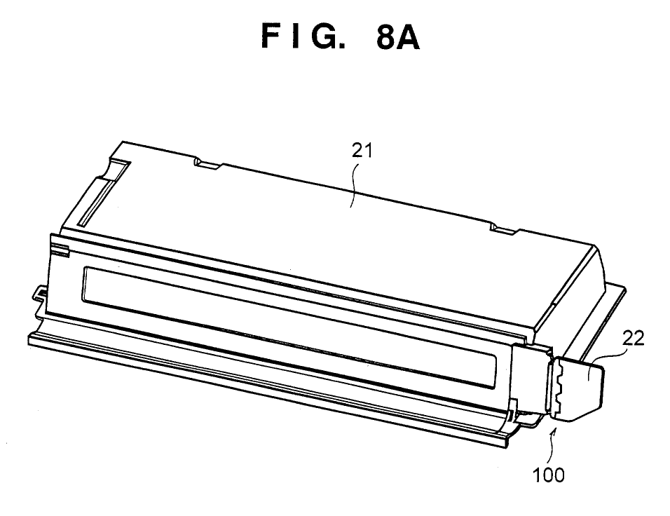

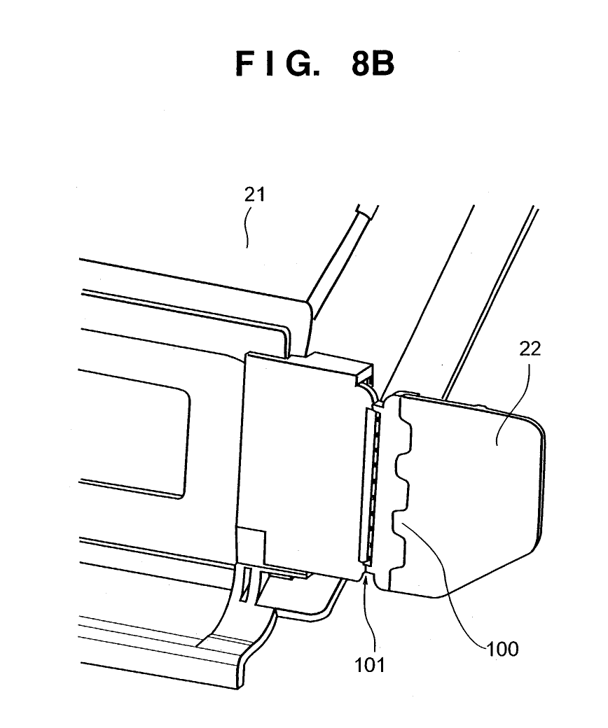

FIG. 8A is a view showing an example of a molded article molded by a molding method according to one embodiment of the present invention, which is an ink toner container for a copying machine or laser beam printer. FIG. 8B is an enlarged view of a portion to which the present invention is applied.

Referring to FIG. 8A, reference numeral 21 denotes a toner container main body formed of the first resin; 22, a tab formed of the second resin; 100, a bonding portion for the toner container main body 21 formed of the first resin and the tab 22 formed of the second resin; and 101, a portion where the tab 22 is cut and separated from the toner container main body 21.

In the above arrangement, according to this embodiment, a black resin material is injected from a molding machine to form the toner container main body 21. The tab 22 is formed by using an orange material as the second resin material. Thus, a molded article is molded in which the black toner container main body 21 and the orange tab 22 are bonded to each other.

A seal (not shown) for closing the opening of the toner container main body 21 is connected to the tab 22. When the toner container is to be used, the tab 22 is cut at the cutting/separating portion 101, and is separated together with the seal from the toner container main body 21, so that the toner container main body 21 is opened.

At this time, in order to improve the visibility by the user, the tab 22 preferably has a tone different from that of the black color of the toner container main body 21. In this embodiment, the tab 22 is orange.

To facilitate cutting and separation of the tab 22 from the toner container main body 21, the cutting/separating portion 101 has a partly thin portion. According to this embodiment, the bonding portion 100 has a convexo-concave shape so that it has a sufficiently large bonding strength against the bending strength of the cutting/separating portion 101.

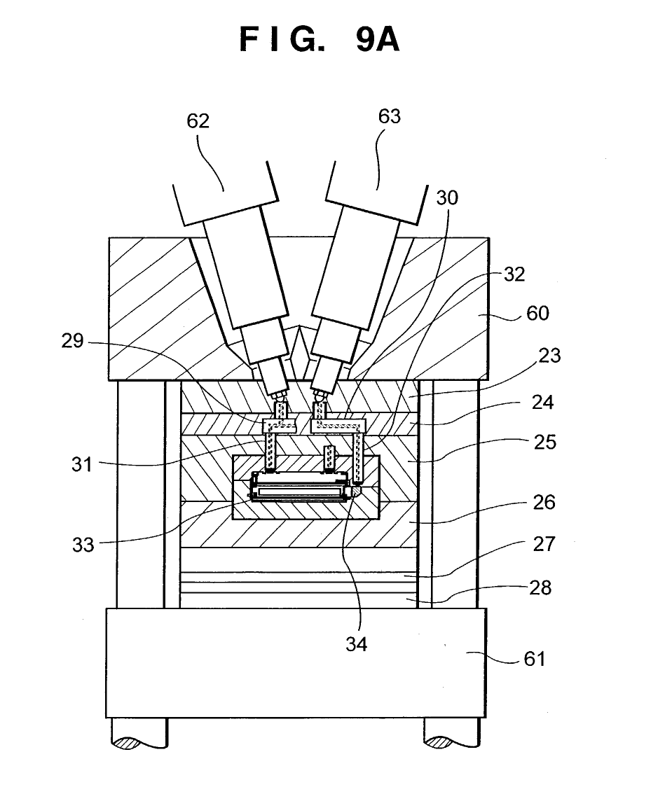

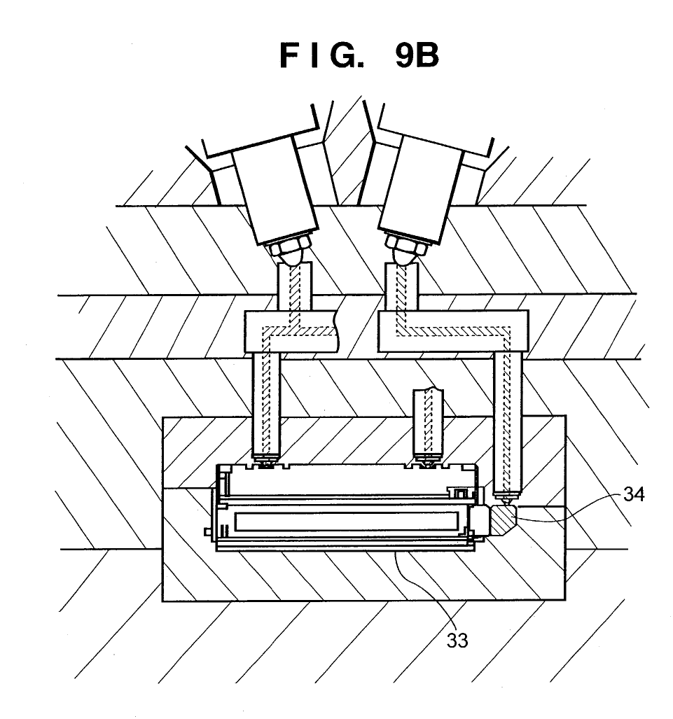

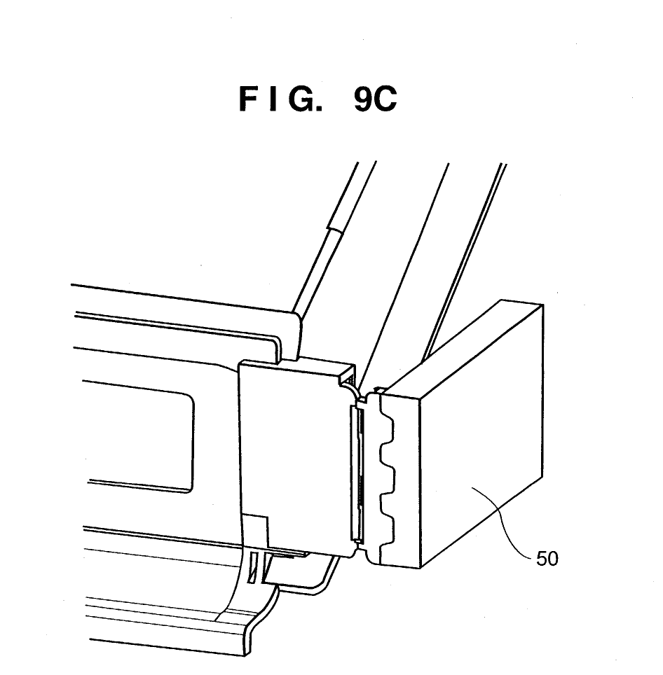

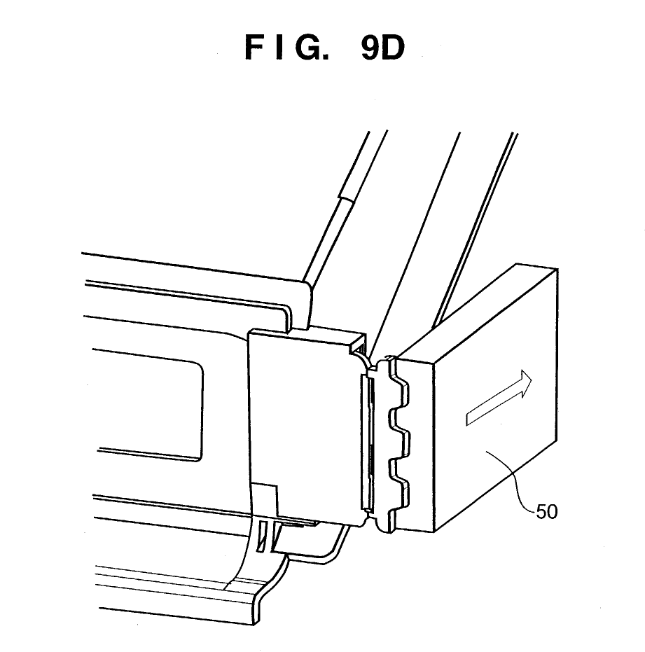

FIG. 9A is an assembly sectional view of an injection mold used in one embodiment of the present invention, FIG. 9B is an enlarged view of a portion around the product portion; and FIGS. 9C and 9D are views in which the bonding portions for the first and second product portions are enlarged to explain the operation of the movable core.

Referring to FIG. 9A, reference numeral 60 denotes a stationary platen for a molding machine; 61, a movable platen for the molding machine; 62, a first injection unit for injecting the first resin; 63, a second injection unit for injecting the second resin; 23, a cavity adapter plate; 24, a manifold block; 25, a cavity plate; 26, a core plate; 27, an ejector plate; and 28, a core adapter plate. These components form the arrangement of a general injection mold that uses a hot runner. Reference numeral 29 denotes a manifold for the first resin; 30, a manifold for the second resin; 31, a valve gate for the first resin; 32, a valve gate for the second resin; 33, a cavity in a product portion formed of the first resin; and 34, a cavity in a product portion formed of the second resin. In FIG. 9C, reference numeral 50 denotes a movable core with a shape that forms the bonding surfaces of the first and second resins.

In the above arrangement, the cavity adapter plate 23 is fixed to the stationary platen 60 of the molding machine, and the core adapter plate 28 is fixed to the movable platen 61 by using a fastening means such as bolt fastening. The first resin injected from the first injection unit 62 of the molding machine passes through the manifold 29 formed in the manifold block 24, and the valve gate 31, to fill the cavity 33. At this time, the flow of the first resin is regulated by the movable core 50 for a predetermined period of time, so that the shape of the bonding surface is formed. When a predetermined period of time has elapsed, the movable core 50 is removed from the cavity 34 of the product portion formed of the second resin, and the second resin is injected from the second injection unit 63 of the molding machine at an appropriate timing. The second resin passes through the manifold 30 and valve gate 32 to fill the cavity 34, and merges with the first resin having the shape of the bonding surface. Thus, a two-color or two-material molded article in which the first and second resins are bonded to each other is molded.

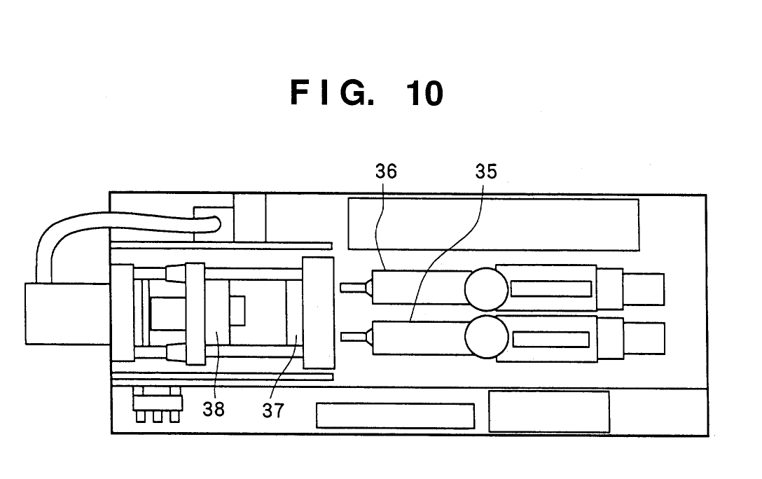

FIG. 10 is a view showing an example of a general two-color molding machine used in one embodiment of the present invention.

Referring to FIG. 10, reference numeral 35 denotes an injection unit for injecting the first resin; 36, an injection unit for injecting the second resin; 37, a stationary mold attached to a stationary platen; and 38, a movable mold attached to a movable platen.

In the above arrangement, the injection unit 35 for injecting the first resin and the injection unit 36 for injecting the second resin can be set at different resin molding temperatures. Therefore, the injection unit 35 for injecting the first resin, e.g., black HIPS, can inject the first resin into the cavity formed in the stationary mold 37 and movable mold 38 at a resin molding temperature of 200° C. Subsequently, the injection unit 36 for injecting the second resin, e.g., orange HIPS, which is set at a resin temperature higher than the first resin molding temperature by 10° C. to 30° C., can inject the second resin into the cavity. As the second resin can be injected at the molding temperature higher than the first resin molding temperature by 10° C. to 30° C., a skin layer formed when the skin of the first resin cools can be fused again by the temperature of the second resin. Alternatively, the surface temperature of the first resin is increased to activate its molecules, so that the first resin can be chemically bonded to the second resin. As a result, the adhesion properties of the resins are increased, and the strength of the bonding surfaces can be increased.

As described above, in the above embodiment, a plurality of injection nozzle ports are formed in one mold at separate positions. Molding materials having different colors, or different types of molding materials are injected from the plurality of injection nozzle ports substantially simultaneously. In this case, the movable core is entered in the cavity that forms the shape of the second resin, to temporarily regulate the flow of one resin. After that, the movable core is removed from the cavity, and the second resin is allowed to flow to the bonding interface, thus manufacturing an integral molded article. At this time, the bonding surfaces of the two types of resins may have undulated (convexo-concave) shapes formed of a plurality of straight lines or curved lines, shapes that enlarge more as they enter the opposite members more, shapes that overlap each other on the bonding surfaces in the direction of thickness, or shapes as a composite of these shapes. Then, the bonding areas can be increased to be larger than the areas of bonding surfaces that do not have such shapes, so that the bonding strength of the integral molded article can be increased.

In insert molding of arranging a member formed of resin materials having different compositions or tones in the cavity of the mold in advance, and injecting a molten resin into the cavity, thus integrating the resin material member with the molten resin, the bonding surfaces of the resins may have shapes described above. Then, the areas of the bonding surfaces of the respective resins can be increased, so that the bonding strength of the integral molded article can be increased.

In the above embodiment, a plurality of injection nozzle ports are formed in one mold at separate positions, and molding materials having different colors, or different types of molding materials are injected from the plurality of injection nozzle ports substantially simultaneously. In this case, the movable core is entered in the cavity that forms the shape of the second resin, to temporarily regulate the flow of one resin. After that, the movable core is removed from the cavity, and the second resin is allowed to flow to the bonding interface, thus manufacturing an integral molded article. Therefore, the first resin is blocked by the movable core, and is stopped at the bonding portion. Then, when the movable core is removed and the cavity is opened, the second resin reaches the bonding portion. At the bonding portion, the first resin has already in the cooling step, and has formed a skin layer. Thus, an integral molded article in which the bonding interface from the second resin is defined well can be manufactured.

In the above embodiment, a plurality of injection nozzle ports are formed in one mold at separate positions, and molding materials having different colors, or different types of molding materials are injected from the plurality of injection nozzle ports substantially simultaneously. In this case, the movable core is entered in the cavity that forms the shape of the second resin, to temporarily regulate the flow of one resin. After that, the movable core is removed from the cavity, and the molding temperature of the second resin is increased to be higher than that of the first resin, so that the second resin flows to the bonding interface. As a result, an integral molded article with a rigidity larger than the bonding strength of the materials having the same molding temperature can be manufactured.

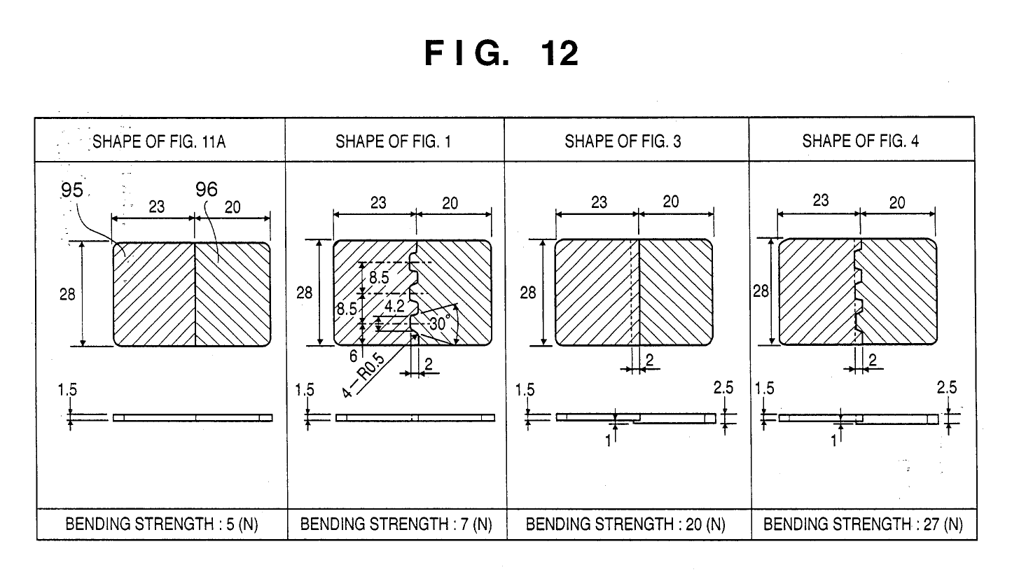

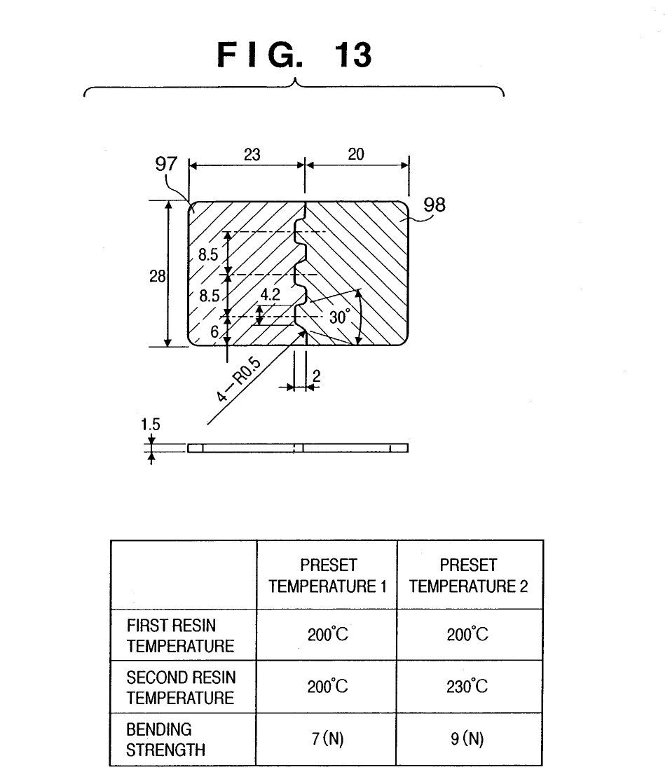

FIGS. 12 and 13 show results obtained by confirming the above effects through experiments.

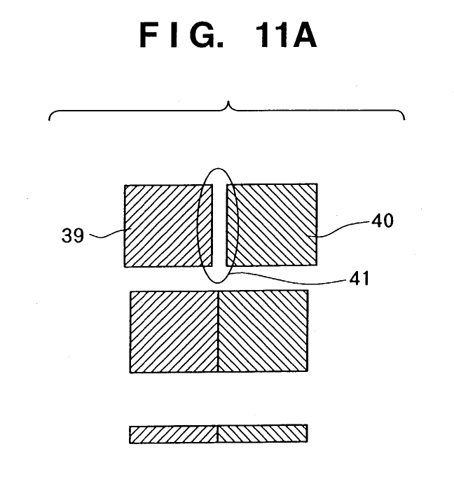

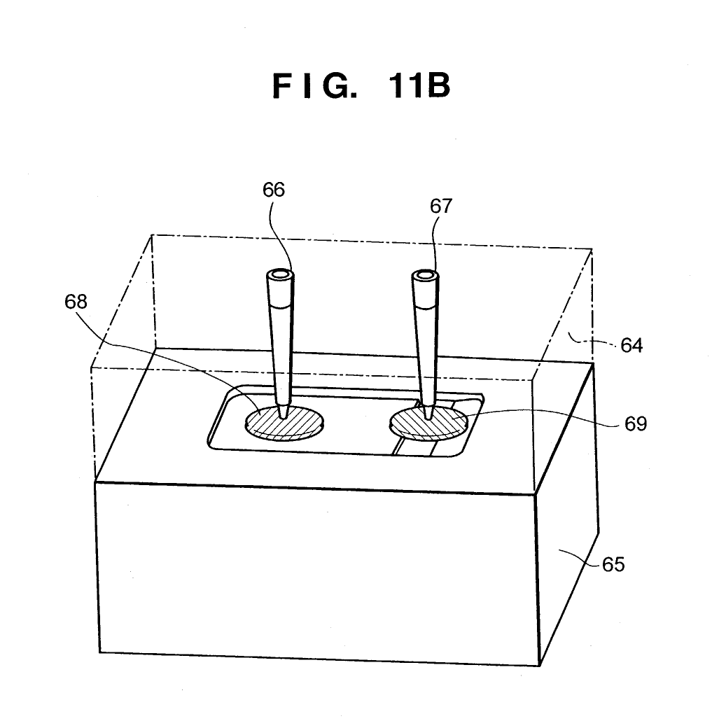

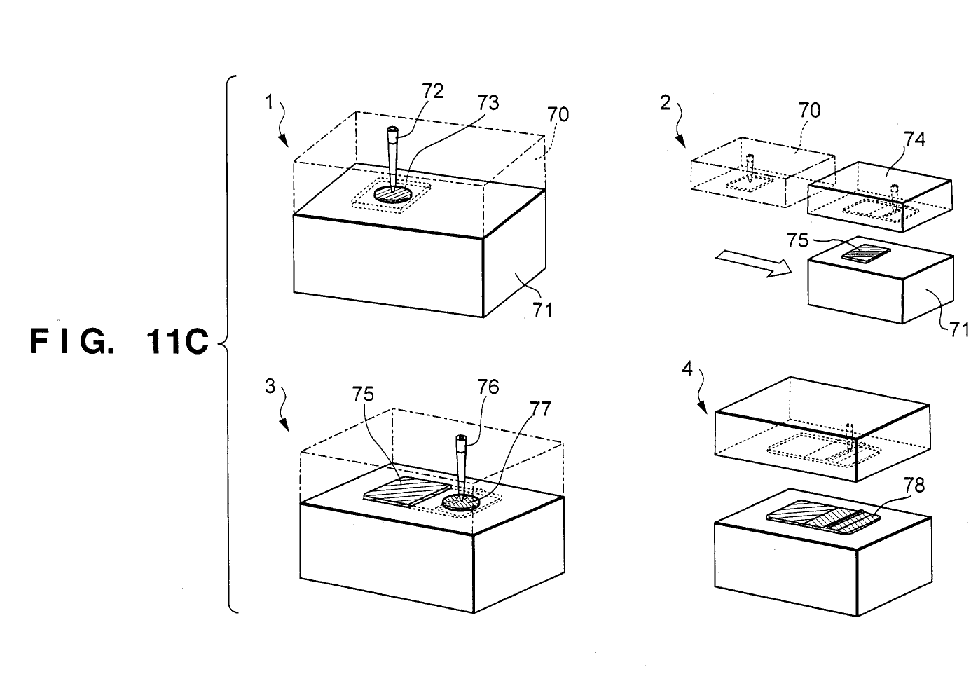

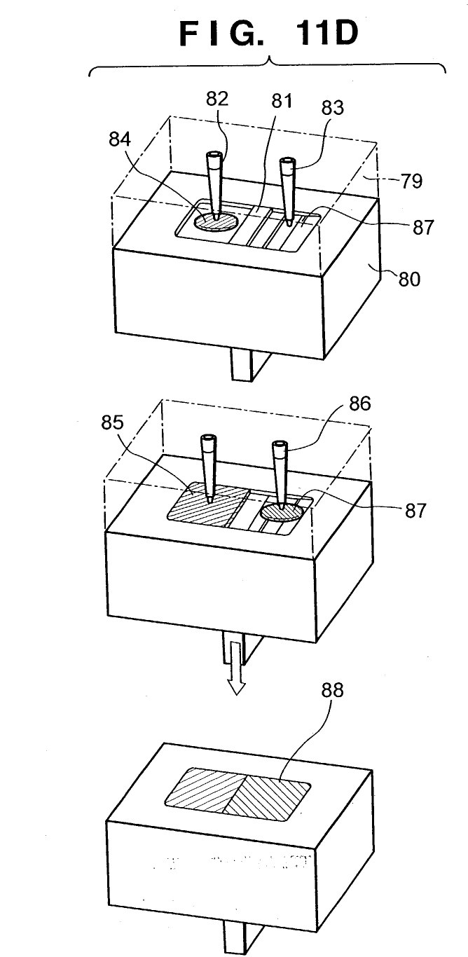

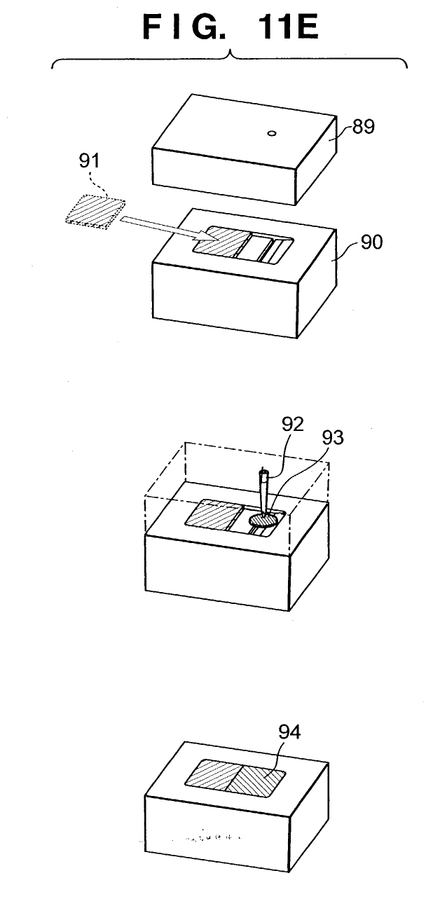

FIG. 12 includes views for comparing the bonding strengths of the injection-molded articles as the embodiments shown in FIGS. 1, 3, and 4 with that of the conventional injection-molded article shown in FIG. 11A. Reference numeral 95 denotes a product portion formed of the first resin (black HIPS); and 96, a product portion formed of the second resin (orange HIPS). Regarding the strength of the bonding portions, the two ends of an assembly of the product portion 95 formed of the first resin and the product portion 96 formed of the second resin as a whole are supported, and a load is applied the bonding portions concentratedly. The value of the load with which the bonding portions are disengaged is defined as the bending strength.

According to FIG. 12, the bonding strength of the integral molded article of this embodiment is higher than that of the conventional integral molded article.

FIG. 13 includes views and a table for comparing the bonding strength of an injection molded article obtained when the temperature of the second resin is higher than that of the first resin and a case wherein the temperature of the second resin is not higher than that of the first resin. Reference numeral 97 denotes a product portion formed of the first resin (black HIPS); and 98, a product portion formed of the second resin (orange HIPS).

According to FIG. 13, when the temperature of the second resin is set higher than that of the first resin by 30° C., the bonding strength of the integral molded article is higher than in a case wherein the temperature of the second resin is set equal to that of the first resin.

As has been described above, according to the present invention, when two or more types of resin materials having different compositions or tones are integrated in a mold, thus forming a multi-color, multi-material molded article, the strength of the bonding surfaces of the resins can be increased.

As many apparently widely different embodiments of the present invention can be made without departing from the spirit and scope thereof, it is to be understood that the invention is not limited to the specific embodiments thereof except as defined in the appended claims.

What is claimed is:

1. An injection molding method of injecting not less than two types of resin materials having different compositions or tones into a mold, thus producing a molded article in which said at least two types of resin materials are bonded, wherein
bonding portions of the not less than two types of resin materials are shaped in convexo-concave.

2. The method according to claim 1, wherein projecting portions of the convexo-concave shaped portions enlarge more at more distal end portions thereof which enter more opposite resin materials to be bonded.

3. An injection molding method of injecting not less than two types of resin materials having different compositions or tones into a mold, thus producing a molded article in which said at least two types of resin materials are bonded, wherein
bonding portions of said at least two types of resin materials are shaped overlappingly in a direction of thickness thereof.

4. An injection molding method of producing a molded article in which not less than two types of resin materials having different compositions or tones are bonded, comprising:
an arrangement step of arranging at least one resin-molded component in a cavity of a mold in advance; and
an injection step of injecting into the cavity a resin material having a composition or tone different from that of said at least one resin-molded component,
wherein a convexo-concave shape is formed in a bonding portion of said at least one resin-molded component with respect to the resin material which is to be injected into the cavity.

5. The method according to claim 4, wherein at a projecting portion of the convexo-concave shaped portion enlarges more at a more distal end portion thereof which enters more an opposite resin material to be bonded.

6. An injection molding method of producing a molded article in which not less than two types of resin materials having different compositions or tones are bonded, comprising:
an arrangement step of arranging at least one resin-molded component in a cavity of a mold in advance; and
an injection step of injecting into the cavity a resin material having a composition or tone different from that of said at least one resin molded component,
wherein a bonding portion of said at least one resin-molded product is shaped overlappingly in a direction of thickness thereof with respect to the resin material which is to be injected into the cavity.

7. An injection molding method of injecting first and second resin materials having different compositions or tones into a mold, thus producing a molded article in which the first and second resin materials are bonded, comprising:
an entering step of entering, in a second portion of a cavity of the mold which is to be filled with the second resin material, a movable piece for forming a convexo-concave shape in a bonding portion of the first resin material which is to be bonded to the second resin material;
a first injection step of injecting the first resin material into a first portion of the cavity which is to be filled with the first resin material;
a removal step of removing the movable piece from the second portion of the cavity; and
a second injection step of injecting the second resin material into the second portion of the cavity.

8. The method according to claim 7, wherein the movable piece molds a projecting portion of the convexo-concave shaped portion to be formed on the first resin material so as to enlarge more at a more distal end portion thereof which enters more the second resin material to be bonded.

9. The method according to claim 7, wherein a temperature of the second resin material is set to be higher than that of the first resin material.

10. An injection molding method of injecting first and second resin materials having different compositions or tones into a mold, thus producing a molded article in which the first and second resin materials are bonded, comprising:
an entering step of entering, in a second portion of a cavity of the mold which is to be filled with the second resin material, a movable piece for forming a bonding portion of the first resin material which is to be bonded to the second resin material, such that the bonding portion is shaped overlappingly in a direction of thickness thereof with respect to the second resin material;
a first injection step of injecting the first resin material into a first portion of the cavity which is to be filled with the first resin material;
a removal step of removing the movable piece from the second portion of the cavity; and
a second injection step of injecting the second resin material into the second portion of the cavity.

11. The method according to claim 10, wherein a temperature of the second resin material is set to be higher than that of the first resin material.

12. An injection mold for producing a molded article in which first and second resin materials having different compositions or tones are bonded, comprising:
a mold member for defining a cavity having a first portion to be filled with the first resin material and a second portion to be filled with the second resin material; and
a movable piece arranged to be able to enter and removable from the second portion, to form a convexo-concave shape in a bonding portion of the first resin material which is to be bonded to the second resin material.

13. The mold according to claim 12, wherein the movable piece molds a projecting portion of the convexo-concave shape to be formed on the first resin material so as to enlarge more at a more distal end portion thereof which enters more the second resin material to be bonded.

14. An injection mold for producing a molded article in which first and second resin materials having different compositions or tones are bonded, comprising:
a mold member for defining a cavity having a first portion to be filled with the first resin material and a second portion to be filled with the second resin material; and
a movable piece arranged to be able to enter and removable from the second portion, to form a bonding portion of the first resin material which is to be bonded to the second resin material, such that the bonding portion is shaped overlappingly in a direction of thickness thereof with respect to the second resin material.

15. A resin-molded article in which not less than two types of resin materials having different compositions or tones are bonded, wherein bonding portions of the not less than two types of resin materials are shaped in convexo-concave.

16. The article according to claim 15, wherein projecting portions of the convexo-concave shaped portions enlarge more at more distal end portions thereof which enter more opposite resin materials to be bonded.

17. A resin-molded article in which not less than two types of resin materials having different compositions or tones are bonded, wherein bonding portions of the not less than two types of resin materials are shaped overlappingly in a direction of thickness thereof.

18. An insert resin product which is to be integrated in a cavity of a mold with another resin material having a different composition or tone, wherein a bonding portion with another resin material is shaped in convexo-concave.

19. The product according to claim 18, wherein a projecting portion of the convexo-concave shaped portion enlarges more at a more distal end thereof which enters more an opposite resin material to be bonded.

20. An insert resin product which is to be integrated with another resin material having a different composition or tone in a cavity of a mold, wherein a bonding portion of the insert resin product is shaped overlappingly in a direction of thickness with respect to another resin material.

21. A method of performing injection molding to produce a molded article by using a plurality of resin materials, wherein
a movable is core formed in a cavity of a mold for molding the molded article, to have a convexo-concave shape which is to come into contact with a resin, the movable core is positioned in the cavity and a first resin material is injected to form a convexo-concave shape in part of the molded article, then the movable core is removed and a second resin material is injected to a portion from which the movable core has been removed, and a portion of the first resin material which has the convexo-concave shape is fused again at an injection temperature of the second resin material, thereby bonding the first and second resin materials.

22. A toner container having a tab which is molded from a plurality of resin materials having different injection temperatures, wherein
injection for molding a main body portion of the toner container is performed by injecting a first resin material into a cavity of a mold which molds the toner container, then a second injection material having an injection temperature higher than that of the first resin material is injected, and a portion of the second resin material which is in contact with the first resin material is fused again, thereby forming the tab.

23. The container according to claim 22, wherein portions of the first and second resin materials which are in contact with each other have convexo-concave shapes.

24. The container according to claim 23, wherein the convexo-concave shapes have wedges.
